(19) United States
(12) Patent Application Publication
(10) Pub. No.: US 2012/0265908 A1
(43) Pub. Date: Oct. 18, 2012

(54) SERVER AND METHOD FOR BUFFERING MONITORED DATA

(75) Inventors: CHUNG-I LEE, Tu-Cheng (TW); YI-GUO WANG, Shenzhen City (CN); KUAN-CHIAO PENG, Tu-Cheng (TW); JIAN HUANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/445,910

(22) Filed: Apr. 12, 2012

(30) Foreign Application Priority Data
Apr. 15, 2011 (CN) 201110095125.3

(51) Int. Cl. G06F 5/14

(52) U.S. Cl. 710/53

(57) ABSTRACT

A method for buffering monitored data received from a monitoring device. The received monitored data is buffered into a buffer area and all of the monitored data from the buffer area is stored to a database server when a current count of data in the buffer area equals a recycling predetermined count N. An address of the received monitored data is recorded in a data list. When a monitoring server receives request for monitored data from a client server, the required one or more items of monitored data is read from the buffer area and sent to the client server.

### BACKGROUND

1. Technical Field

Embodiments of the present disclosure generally relate to buffer technology, and more particularly to a server and a method for buffering monitored data.

2. Description of Related Art

Response efficiency is very important for real-time monitoring. Usually, data in relation to objects that are monitored (“monitored data”) are stored in a database or a document. However, reading the monitored data from the database or document requires a lot of time, and influences the response efficiency of the real-time monitoring.

### BRIEF DESCRIPTION OF THE DRAWINGS

FIG. 1 is a block diagram of one embodiment of a monitoring server including a buffer unit that buffers monitored data.

FIG. 2 is a block diagram of one embodiment of function modules of the buffer unit.

FIG. 3 is a flowchart of one embodiment of a buffering procedure of a method for buffering monitored data.

FIG. 4 is a flowchart of one embodiment of a feedback procedure of a method for buffering monitored data.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

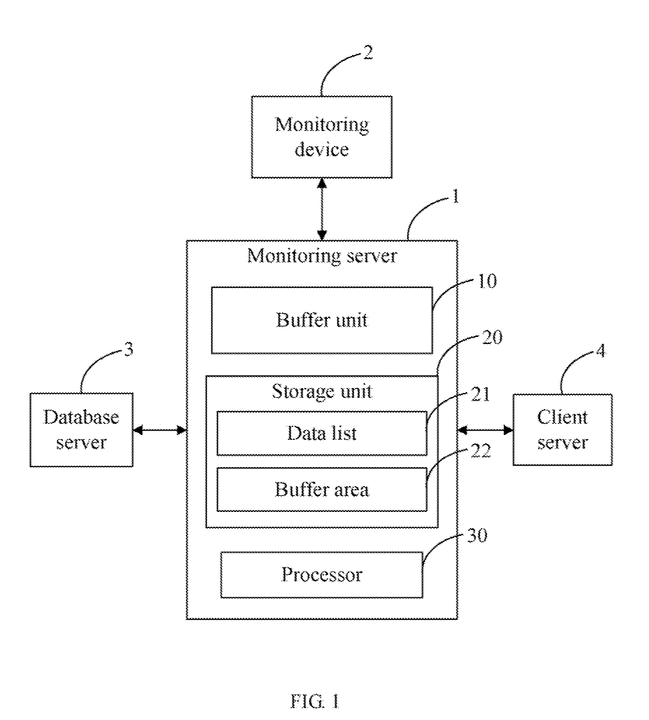

FIG. 1 is a block diagram of one embodiment of a monitoring server 1 including a buffer unit 10 that buffers monitored data. The monitoring server 1 further includes a storage unit 20 and a processor 30. The monitoring server 1 electrically connects to a monitoring device 2, a database server 3 and a client server 4.

The monitoring device 2, for example, a camera, a sound monitor, or an alarm detector, monitors nearby objects and sends monitored data in relation to the objects to the monitoring server 1. The monitoring server 1 receives the monitored data from the monitoring device 2. The database server 3 stores the monitored data. The client server 4 sends a request for the retrieval of the monitored data to the monitoring server 1 and receives corresponding monitored data from the monitoring server 1.

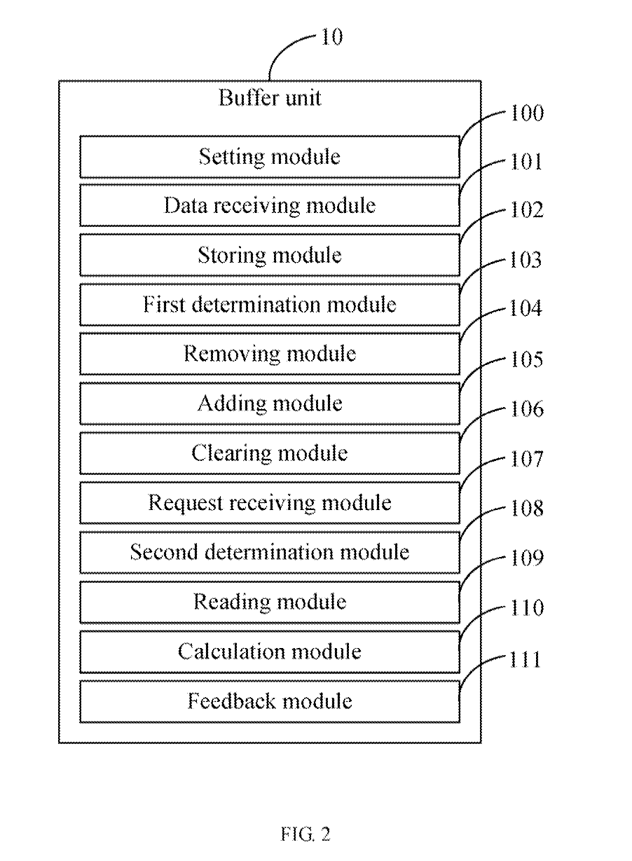

In one embodiment, the buffer unit 10 may include one or more function modules (detailed description is given in FIG. 2). The one or more function modules may comprise computerized code in the form of one or more programs that are stored in the storage unit 20, and executed by the processor 30 to provide the functions of the buffer unit 10. The storage unit 20 may be a cache or a dedicated memory, such as an EPROM or a flash memory.

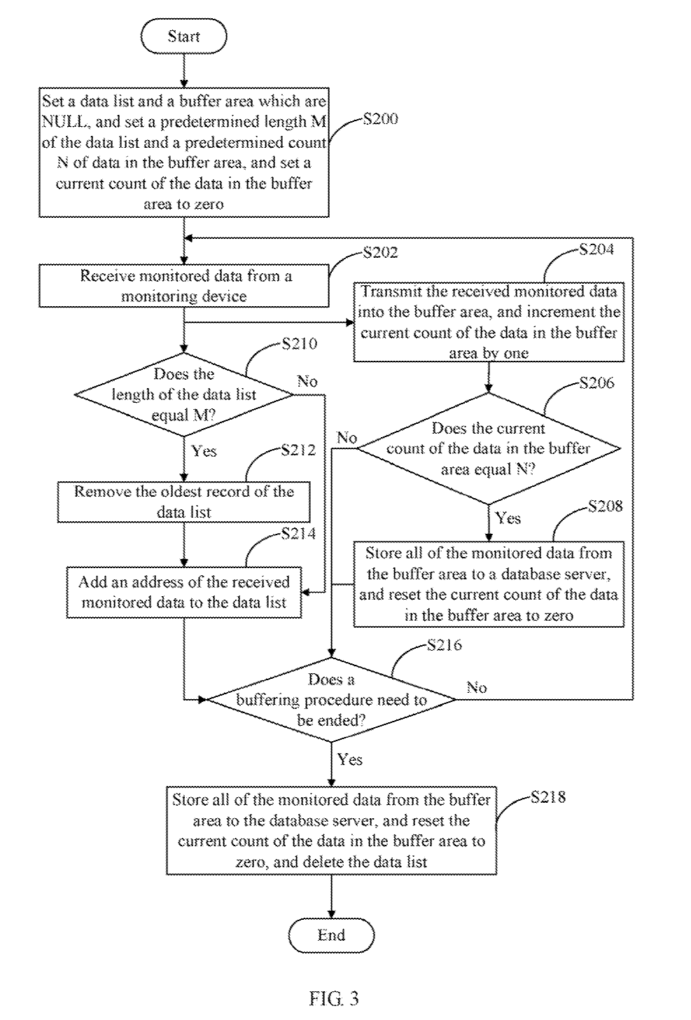

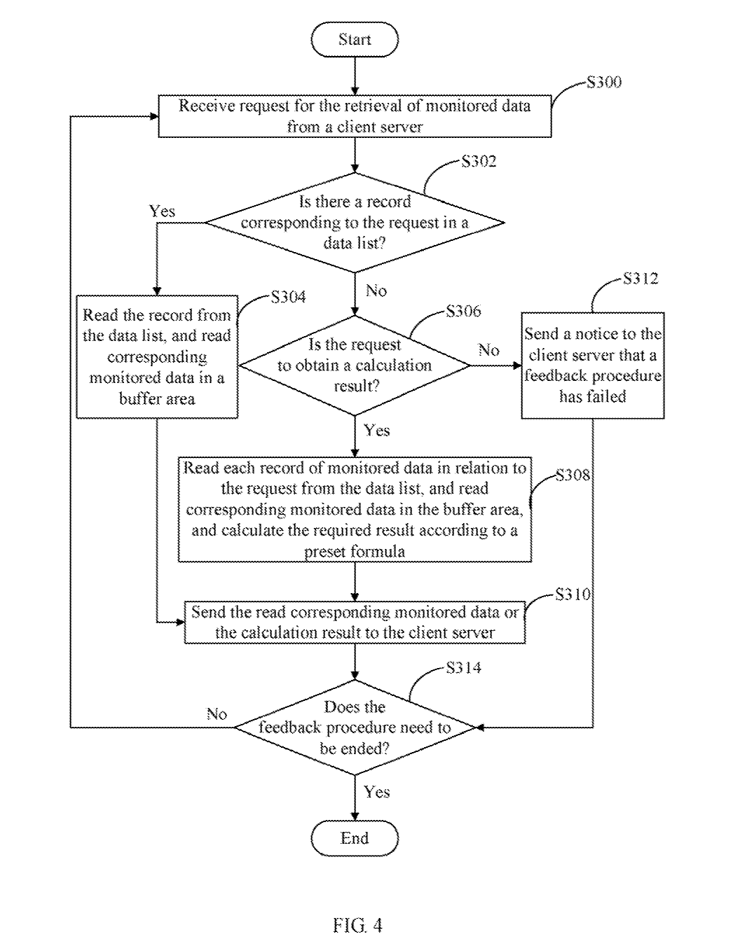

FIG. 2 is a block diagram of one embodiment of the function modules of the buffer unit 10. In one embodiment, the buffer unit 10 includes a setting module 100, a data receiving module 101, a storing module 102, a first determination module 103, a removing module 104, an adding module 105, a clearing module 106, a request receiving module 107, a second determination module 108, a reading module 109, a calculation module 110, and a feedback module 111. A detailed description of the functions of the modules 100-111 is given in FIG. 3 and FIG. 4.

FIG. 3 is a flowchart of one embodiment of a buffering procedure of a method for buffering monitored data. Depending on the embodiment, additional steps may be added, others removed, and the ordering of the steps may be changed.

In step S200, the setting module 100 sets a data list 21 and a buffer area 22 which are NULL, and sets a predetermined length M of the data list 21 and a predetermined count N of data in the buffer area 22, and sets a current count of the data in the buffer area 22 to zero. The buffer area 22 is an area in the storage unit 20 which buffers the monitored data. When the client server 4 sends a request for the retrieval of the monitored data to the monitoring server 1, the required monitored data is read from the buffer area 22 and sent to the client server 4. The data list 21 is a list in the storage unit 20, which comprises more than one node, where each node records an address of the monitored data in the buffer area 22. Once the monitored data is buffered into the buffer area 22, the adding module 105 increments the current count of the data in the buffer area 22 by one.

In step S202, the data receiving module 101 receives the monitored data from the monitoring device 2. In step S202-S208, the monitored data is buffered in the buffer area 22, and stored in the database server 3. In step S210-S214, an address of the monitored data in the buffer area 22 is recorded in the data list 21, for searching the monitored data in the feedback procedure.

In step S204, the storing module 102 transmits the received monitored data into the buffer area 22, and increments the current count of the data in the buffer area 22 by one. In one embodiment, the monitored data is buffered into the buffer area applying a Linq to SQL technology.

In step S206, the first determination module 103 determines whether the current count of the data in the buffer area 22 equals the predetermined number N. If the current count of the data in the buffer area 22 equals the predetermined number N, step S208 is implemented. If the current count of the data in the buffer area 22 does not equal the predetermined number N, step S216 is implemented.

In step S208, the storing module 102 stores all of the monitored data from the buffer area 22 to the database server 3, and resets the current count of the data in the buffer area 22 to zero.

In step S210 (following the step S202), the first determination module 103 determines whether the length of the data list 21 equals the predetermined length M. If the length of the data list 21 equals the predetermined length M, step S212 is implemented. If the length of the data list 21 does not equal the predetermined length M, step S214 is implemented.

In step S212, the removing module 104 removes the oldest record of the data list 21, then step S214 is implemented. The oldest record is an address of monitored data which is recorded earliest into the data list 21 (in the first node). In one embodiment, the removing module 104 removes the oldest record applying the First In First Out (FIFO) principle. Each node of the data list 21 simply records an address but not the monitored data itself, so all of the nodes are of the same size.

In step S214, the adding module 105 adds an address of the received monitored data to the data list 21. The address indicates the space or location in the buffer area 22 where the received monitored data is stored. After removing the oldest record (clearing the first node), the records in remaining nodes of the data list 21 all move forwards, and the adding module 105 adds the address of the received monitored data to the last node of the data list 21.

In step S216, the first determination module 103 determines whether the buffering procedure needs to be ended. In the embodiment, if no new monitored data is received from the monitoring device 2 within a preset period of time, the buffering procedure needs to be ended. If the buffering procedure needs to be ended, step S218 is implemented. Until the buffering procedure ends, the procedure remains at step S202.

In step S218, the clearing module 106 stores all of the monitored data from the buffer area 22 to the database server 3, and resets the current count of the data in the buffer area 22 to zero, and deletes the data list 21. If the steps S206 and S208 have been implemented, all of the monitored data from the buffer area 22 has been stored into the database server 3 and the current count of data in the buffer area 22 has been reset to zero, therefore, in step S218, the clearing module 106 just deletes the data list 21.

FIG. 4 is a flowchart of one embodiment of a feedback procedure of a method for buffering monitored data. Depending on the embodiment, additional steps may be added, others removed, and the ordering of the steps may be changed.

In step S300, the request receiving module 107 receives request for the retrieval of monitored data from the client server 4.

In step S302, the second determination module 108 determines whether there is a record corresponding to the request in the data list 21. In the embodiment, the record corresponding to the request records an address of monitored data. If there is a record corresponding to the request in the data list 21, step S304 is implemented. If there is not a record corresponding to the request in the data list 21, step S306 is implemented.

In step S304, the reading module 109 reads the record from the data list 21, and reads the corresponding monitored data in the buffer area 22.

In step S306, the second determination module 108 determines whether the request is to obtain a calculation result. In the embodiment, the client server 4 may request a calculation result relating to more than one item of monitored data. For example, if the client server 4 requests a PUE data, this is a ratio which puts a certain hardware power against another hardware power. In the embodiment, there is an attribute of the request which is indicates whether the request is to obtain a calculation result. For example, if the attribute is 0, the request is not to obtain a calculation result, and step S312 is implemented. If the attribute is 1, the request is to obtain a calculation result, and step S308 is implemented.

In step S308, the calculation module 110 reads each record of monitored data in relation to the request from the data list 21, and reads corresponding monitored data in the buffer area 22, and calculates the required result according to a preset formula. Different requests may require or correspond to different formulas, and the different formulas are preset and stored in a list or a document.

In step S310, the feedback module 111 sends the read corresponding monitored data, or the calculation result as the case may be, to the client server 4.

In step S312, the feedback module 111 sends a notice to the client server 4 that the feedback procedure has failed.

In step S314, the second determination module 108 determines whether the feedback procedure needs to be ended. In the embodiment, the users may select the termination of the feedback procedure. If the feedback procedure needs to be ended, the feedback procedure is ended. Until termination of the feedback procedure is selected, the feedback procedure remains at step S300.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for buffering monitored data by a processor of a server, comprising:
(a) setting a data list and a buffer area which are NULL, and setting a predetermined length M of the data list and a predetermined count N of data in the buffer area, and setting a current count of data in the buffer area to zero;
(b) receiving monitored data from a monitoring device, and implementing step (c) and then step (e);
(c) transmitting the received monitored data into the buffer area, and incrementing the current count of the data in the buffer area by one, then implementing step (d);
(d) storing all of the monitored data from the buffer area in a database server, and resetting the current count of the data in the buffer area to zero in response that the current count of the data in the buffer area equals the predetermined count N, then implementing step (g);
(e) removing the oldest record of the data list in response that the length of the data list equals the predetermined length M, then implementing step (f);
(f) adding an address of the received monitored data to the data list in response that the length of the data list does not equal the predetermined length M or the oldest record of the data list has been removed, then implementing step (g); and
(g) storing all of the monitored data from the buffer area in the database server, and resetting the current count of the data in the buffer area to zero, and deleting the data list.

2. The method as claimed in claim 1, wherein in the step (c), the monitored data is buffered into the buffer area applying a Linq to SQL technology.

3. The method as claimed in claim 1, wherein in the step (e), the oldest record is removed applying the First In First Out principle.

4. The method as claimed in claim 1, wherein the method further comprising:
receiving request for the retrieval of monitored data from a client server;
reading a record corresponding to the request from the data list, and reading corresponding monitored data in the buffer area in response that there is a record corresponding to the request in the data list;
reading each record of monitored data in relation to the request from the data list, and reading corresponding monitored data in the buffer area, and calculating a required result according to a preset formula in response that the request is to obtain a calculation result; and
sending the read corresponding monitored data or the calculation result to the client server.

5. The method as claimed in claim 4, wherein the method further comprising:
sending a notice to the client server that a feedback procedure has failed in response that there is not a record corresponding to the request in the data list and the request is not to obtain a calculation result.

6. A non-transitory storage medium storing a set of instructions, the set of instructions capable of being executed by a processor of a server to perform a method for buffering monitored data, the server being connected to a monitoring device, a database server and a client server, the method comprising:
(a) setting a data list and a buffer area which are NULL, and setting a predetermined length M of the data list and a predetermined count N of data in the buffer area, and setting a current count of data in the buffer area to zero;
(b) receiving monitored data from the monitoring device, and implementing step (c) and then step (e);
(c) transmitting the received monitored data into the buffer area, and incrementing the current count of the data in the buffer area by one, then implementing step (d);
(d) storing all of the monitored data from the buffer area in the database server, and resetting the current count of the data in the buffer area to zero in response that the current count of the data in the buffer area equals the predetermined count N, then implementing step (g);
(e) removing the oldest record of the data list in response that the length of the data list equals the predetermined length M, then implementing step (f);
(f) adding an address of the received monitored data to the data list in response that the length of the data list does not equal the predetermined length M or the oldest record of the data list has been removed, then implementing step (g); and
(g) storing all of the monitored data from the buffer area in the database server, and resetting the current count of the data in the buffer area to zero, and deleting the data list.

7. The non-transitory storage medium as claimed in claim 6, wherein in the step (c), the monitored data is buffered into the buffer area applying a Linq to SQL technology.

8. The non-transitory storage medium as claimed in claim 6, wherein in the step (e), the oldest record is removed applying the First In First Out principle.

9. The non-transitory storage medium as claimed in claim 6, wherein the method further comprising:
receiving request for the retrieval of monitored data from the client server;
reading a record corresponding to the request from the data list, and reading corresponding monitored data in the buffer area in response that there is a record corresponding to the request in the data list;
reading each record of monitored data in relation to the request from the data list, and reading corresponding monitored data in the buffer area, and calculating a required result according to a preset formula in response that the request is to obtain a calculation result; and
sending the read corresponding monitored data or the calculation result to the client server.

10. The non-transitory storage medium as claimed in claim 9, wherein the method further comprising:
sending a notice to the client server that a feedback procedure has failed in response that there is not a record corresponding to the request in the data list and the request is not to obtain a calculation result.

11. A server, the server being connected to a monitoring device, a database server and a client server, the server comprising:
a storage unit;
at least one processor; and
one or more programs stored in the storage unit, executable by the at least one processor, the one or more programs comprising:
a setting module operable to set a data list and a buffer area which are NULL, and set a predetermined length M of the data list and a predetermined count N of data in the buffer area, and set a current count of data in the buffer area to zero;
a data receiving module operable to receiving monitored data from the monitoring device;
a storing module operable to transmit the received monitored data into the buffer area, and increment the current count of the data in the buffer area by one;
the storing module further operable to store all of the monitored data from the buffer area in the database server, and reset the current count of the data in the buffer area to zero in response that the current count of the data in the buffer area equals the predetermined count N;
a removing module operable to remove the oldest record of the data list in response that the length of the data list equals the predetermined length M;
an adding module operable to add an address of the received monitored data to the data list in response that the length of the data list does not equal the predetermined length M or the oldest record of the data list has been removed; and
a clearing module operable to store all of the monitored data from the buffer area in the database server, and reset the current count of the data in the buffer area to zero, and delete the data list.

12. The server as claimed in claim 11, wherein the monitored data is buffered into the buffer area applying a Linq to SQL technology.

13. The server as claimed in claim 11, wherein the removing module removes the oldest record applying the First In First Out principle.

14. The server as claimed in claim 11, wherein the one or more programs further comprising:
a request receiving module operable to receive request for the retrieval of monitored data from the client server;
a reading module operable to read a record corresponding to the request from the data list, and read corresponding monitored data in the buffer area in response that there is a record corresponding to the request in the data list;
a calculation module operable to read each record of monitored data in relation to the request from the data list, and read corresponding monitored data in the buffer area, and calculate a required result according to a preset formula in response that the request is to obtain a calculation result; and
a feedback module operable to send the read corresponding monitored data or the calculation result to the client server.

15. The server as claimed in claim 14, wherein the feedback module further operable to send a notice to the client server that a feedback procedure has failed in response that there is not a record corresponding to the request in the data list and the request is not to obtain a calculation result.
